(19) United States
(12) Patent Application Publication
(10) Pub. No.: US 2025/0287486 A1
(43) Pub. Date: Sep. 11, 2025

(54) POWER SAVE DIMMING CONTROL FOR MULTI-CHANNEL LED CONTROLLER

(71) Applicant: TEXAS INSTRUMENTS INCORPORATED, DALLAS, TX (US)

(72) Inventors: Yichao TANG, SHANGHAI (CN); Yanqin CAO, SHAANXI (CN); Moon ZHANG, SHANGHAI (CN); Ben WAAL, SHANGHAI (CN)

(21) Appl. No.: 18/598,224

(22) Filed: Mar. 7, 2024

(51) Int. Cl. H05B 45/48

(52) U.S. Cl. CPC H05B 45/48

(57) ABSTRACT

A circuit includes a plurality of switches, each switch of the plurality of switches having a respective first switch terminal, a respective second switch terminal and a respective switching terminal. The circuit further includes a switch logic circuit including a plurality of switch logic input terminals, a plurality of switch logic output terminals and a switch control terminal, each switch logic output terminal of the plurality of switch logic output terminals being coupled to the switching terminal of a respective one of the plurality of switches. Furthermore, the circuit includes a switching driver control circuit including a plurality of driver input terminals, a driver output terminal and a driver logic terminal, the driver logic terminal being coupled to the switch control terminal of the switch logic circuit, and each of the plurality of driver input terminals being coupled to a respective one of the plurality of switch logic input terminals.

### TECHNICAL FIELD

This description relates to light emitting diode (LED) lighting control systems, in particular, to a system that facilitates dimming control of LED arrays in LED lighting systems.

### BACKGROUND

Light emitting diodes (LEDs) are highly energy efficient and rapidly developing lighting technology. LED lighting is utilized in a variety of home, automotive, and industrial products. The high-efficiency and directional nature of LEDs makes them useful for many industrial uses. LEDs are increasingly used as matrix lighting, such as stage lighting, vehicle lighting, surgical lighting etc., where LEDs are arranged as an array of individually addressable and controllable LEDs.

LED dimming is the process of adjusting the brightness of LED lights. Dimming LED lights can save money and energy and increase their lifespan. There are two main methods of dimming LEDs: Pulse Width Modulation (PWM) dimming and analog dimming. PWM dimming is a method that switches the LED on and off rapidly at a high frequency, which creates the illusion of dimming. Analog dimming is a method that regulates the current that flows through the LED, which in turn controls its brightness.

### SUMMARY

An example circuit includes a plurality of switches, each switch of the plurality of switches having a respective first switch terminal, a respective second switch terminal and a respective switching terminal. The circuit further includes a switch logic circuit including a plurality of switch logic input terminals, a plurality of switch logic output terminals and a switch control terminal, each switch logic output terminal of the plurality of switch logic output terminals being coupled to the switching terminal of a respective one of the plurality of switches. Further, the circuit includes a switching driver control circuit including a plurality of driver input terminals, a driver output terminal and a driver logic terminal, the driver logic terminal being coupled to the switch control terminal of the switch logic circuit, and each of the plurality of driver input terminals being coupled to a respective one of the plurality of switch logic input terminals.

Another example circuit includes a plurality of switches configured to turn on or turn off based on a respective plurality of switch control signals. The circuit further includes a switch logic circuit configured to provide the respective plurality of switch control signals based on a respective plurality of controller output signals and a switch logic signal and a switching driver control circuit configured to provide the switch logic signal based on the respective plurality of controller output signals.

A yet another example includes a system including a plurality of light emitting diodes (LEDs) coupled in series between a series input terminal and a series output terminal; and a switching LED driver circuit configured to provide an LED current to the plurality of LEDs. The system further includes a plurality of switches in which each switch is coupled in parallel with a respective one of the plurality of LEDs, wherein the plurality of switches is configured to turn on or turn off based on a respective plurality of switch control signals; and a switch logic circuit configured to provide the respective plurality of switch control signals based on a respective plurality of controller output signals and a switch logic signal. Further, the system includes a switching driver control circuit configured to provide the switch logic signal to the switch logic circuit and a driver output signal to control the switching LED driver circuit, based on the respective plurality of controller output signals; and a controller circuit configured to provide the respective plurality of controller output signals to the switch logic circuit and the switching driver control circuit.

### BRIEF DESCRIPTION OF THE DRAWINGS

FIG. 1 illustrates a block diagram of an example system.

FIG. 2A, FIG. 2B, FIG. 2C and FIG. 2D illustrates an example dimming cycle of an LED lighting system at different time instances t1, t2, t3 and t4, respectively.

FIG. 3 illustrates an example plot depicting the dimming cycle of the LED lighting system in FIG. 2A, FIG. 2B, FIG. 2C and FIG. 2D.

FIG. 4 illustrates a block diagram of an example system.

FIG. 5 depicts an example plot of waveforms of the system in FIG. 4.

FIG. 6 illustrates an example driver output signal generation circuit.

### DETAILED DESCRIPTION

This description relates to circuits and systems that facilitates dimming control of LED arrays in LED lighting systems. In the examples described herein, pulse width modulation (PWM) dimming is utilized to achieve the dimming control of LED array.

In an example, a system includes a plurality of light emitting diodes (LEDs) coupled in series between a series input terminal and a series output terminal, and a switching LED driver circuit configured to provide an LED current to the plurality of LEDs. The system further includes a controller circuit that includes a plurality of switches in which each switch is coupled in parallel with a respective one of the plurality of LEDs. The plurality of switches is configured to be turned on or turned off to facilitate the turn on and turn off of the LEDs. In particular, when a switch that is coupled in parallel to an LED is turned on, the LED current from the switching LED driver circuit passes through the switch and bypasses the LED, thereby turning off the LED. Similarly, when a switch that is coupled in parallel to an LED is turned off, the LED current from the switching LED driver circuit passes through the LED, thereby turning on the LED.

To achieve dimming, one or more LEDs of the plurality of LEDs are turned on or turned off at different instances, based on the turning on or turning off of the corresponding one or more switches. Further, in some instances, the switching LED driver circuit is turned off. In some examples, all the switches of the plurality of switches are also turned off synchronously with the turning off of the switching LED driver circuit. When the switching LED driver circuit and the plurality of switches are turned off, a residual inductor current flows through the plurality of LEDs for a short time period until the residual inductor current drops to zero. Once the residual inductor current drops to zero, all the LEDs of the plurality of LEDs would be turned off. In some examples, synchronously turning off the switching LED driver circuit and the plurality of switches achieves a dimming period where all the LEDs are turned off with minimum power loss. By contrast, if the plurality of switches is turned on while the switching LED driver circuit is turned off, the residual inductor current will flow through the plurality of switches thereby resulting in conduction loss through the plurality of switches.

In some examples, the system can include two or more plurality of LEDs coupled in series to one another, and two or more plurality of controller circuits, each controller circuit including a respective plurality of switches in which each switch is coupled in parallel with a respective one of a respective plurality of LEDs of the two or more plurality of LEDs. The switching LED driver circuit may be configured to provide the LED current to the two or more plurality of LEDs. In order to achieve dimming in such examples, one or more LEDs of a respective plurality of LEDs are turned on or turned off at different instances, based on the turning on or turning off of the corresponding one or more switches of a respective controller circuit. Further, in some instances, the switching LED driver circuit is turned off. In some examples, the plurality of switches of each of the two or more plurality of controller circuits are also turned off synchronously with the turning off of the switching LED driver circuit.

Synchronously turning off the plurality of switches associated with the controller circuit(s) and the switching LED driver circuit can enable systems and method described herein to save up to or greater than 90% power loss at LED low-brightness (e.g., when all the LEDs are turned off) and at PWM dimming switching frequencies of >20 kHz. This power saving feature makes the systems and circuits described herein appropriate for industrial dynamic lighting, such as stage/atmosphere lighting, surgical lighting, medical illumination, 3D printing, automotive beaming, machine vision, etc.

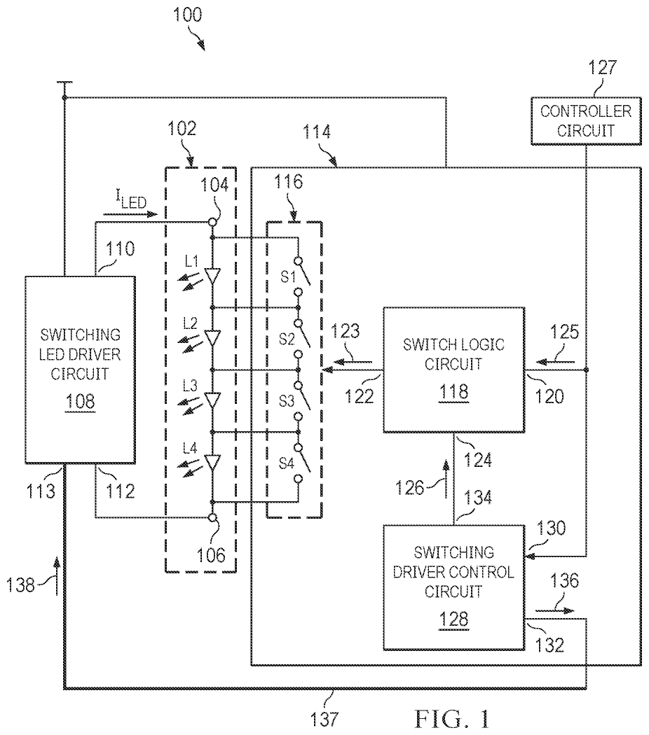

FIG. 1 illustrates a block diagram of an example system 100. In some examples, the system 100 includes a light emitting diode (LED) lighting system that facilitates dimming control of an LED array 102. The LED array 102 that includes a plurality of LEDs L1, L2, L3 and L4 coupled in series between a series input terminal 104 and a series output terminal 106 of the LED array 102. In this example, the plurality of LEDs includes only four LEDs, that is, L1, L2, L3 and L4. However, in other examples, the plurality of LEDs can have more or less than four LEDs. The system 100 further includes a switching LED driver circuit 108 having a first terminal 110 coupled to the series input terminal 104 of the LED array 102 and a second terminal 112 coupled to the series output terminal 106 of the LED array 102. The switching LED driver circuit 108 is configured to provide an LED current I_{LED} to the plurality of LEDs L1, L2, L3 and L4. The switching LED driver circuit 108 further includes an LED driver control input 113.

The system 100 further includes a controller circuit 114 that includes a switch circuit 116 having a plurality of switches S1, S2, S3 and S4, each switch of the plurality of switches having a respective first switch terminal, a respective second switch terminal and a respective switching terminal. The plurality of switches S1, S2, S3 and S4 is coupled in series to one another via the respective first switch terminals and the second switch terminals. In this example, the plurality of switches includes four switches S1, S2, S3 and S4. However, in other examples, the plurality of switches can include more or less than four switches. Each switch of the plurality of switches S1, S2, S3 and S4 is coupled in parallel with a respective one of the plurality of LEDs L1, L2, L3 and L4. In particular, in this example, S1 is coupled in parallel to L1, S2 is coupled in parallel to L2, S3 is coupled in parallel to L3 and S4 is coupled in parallel to L4. The controller circuit 114 further includes a switch logic circuit 118 including a plurality of switch logic input terminals 120, a plurality of switch logic output terminals 122 and a switch control terminal 124. The plurality of switch logic input terminals 120 and the plurality of switch logic output terminals 122 are depicted herein as single terminals for ease of reference. Each switch logic output terminal of the plurality of switch logic output terminals 122 is coupled to the switching terminal of a respective one of the plurality of switches S1, S2, S3 and S4.

The switch logic circuit 118 is configured to provide a respective plurality of switch control signals 123 at the respective switch logic output terminals 122. The plurality of switch control signals 123 is depicted herein as a single switch control signal 123 for the case of reference. Further, the numeral 123 is used herein interchangeably to refer to a single switch control signal and the plurality of switch control signals. The plurality of switches S1, S2, S3 and S4 are configured to turn on or turn off based on the respective plurality of switch control signals 123. The switch logic circuit 118 is configured to provide the respective plurality of switch control signals 123 based on a respective plurality of controller output signals 125 at the plurality of switch logic input terminals 120 and a switch logic signal 126 at the switch control terminal 124. In particular, the switch control signal 123 at each of the plurality of switch logic output terminals 122 is determined based on a value of a respective one of the plurality of controller output signals 125 and a value of the switch logic signal 126. The plurality of controller output signals 125 is depicted herein as a single controller output signal 125 for the case of reference. Further, the numeral 125 is used herein interchangeably to refer to a single controller output signal and the plurality of controller output signals.

The controller circuit 114 further includes a switching driver control circuit 128 that includes a plurality of driver input terminals 130, a driver output terminal 132 and a driver logic terminal 134. The plurality of driver input terminals 130 is depicted herein as a single terminal for case of reference. The driver logic terminal 134 is coupled to the switch control terminal 124 of the switch logic circuit 118, and each of the plurality of driver input terminals 130 is coupled to a respective one of the plurality of switch logic input terminals 120. Further, the driver output terminal 132 is coupled to the LED driver control input 113 of the switching LED driver circuit 108 via a global BUS 137. The switching driver control circuit 128 is configured to provide the switch logic signal 126 at the switch control terminal 124 and a driver output signal 136 at the driver output terminal 132 based on the respective plurality of controller output signals 125. In some examples, the switching driver control circuit 128 is configured to provide the driver output signal 136 to the global BUS 137 that is coupled to the LED driver control input 113, in order to control the switching LED driver circuit 108. In some examples, the global BUS 137 provides a driver control signal 138 to the LED driver control input 113 based on the driver output signal 136, and the switching LED driver circuit 108 is turned on or off responsive to the value of the driver control signal 138. When the switching LED driver circuit 108 is turned on responsive to the driver control signal 138, the switching LED driver circuit 108 is configured to provide the LED current I_{LED}. When the switching LED driver circuit 108 is turned off responsive to the driver control signal 138, the switching LED driver circuit 108 does not provide the LED current I_{LED}. In some examples, the controller circuit 114 may be implemented as an integrated circuit (IC). The system 100 further includes a controller circuit 127 configured to provide the plurality of controller output signals 125 respectively to the plurality of switch logic input terminals 120 and the plurality of driver input terminals 130.

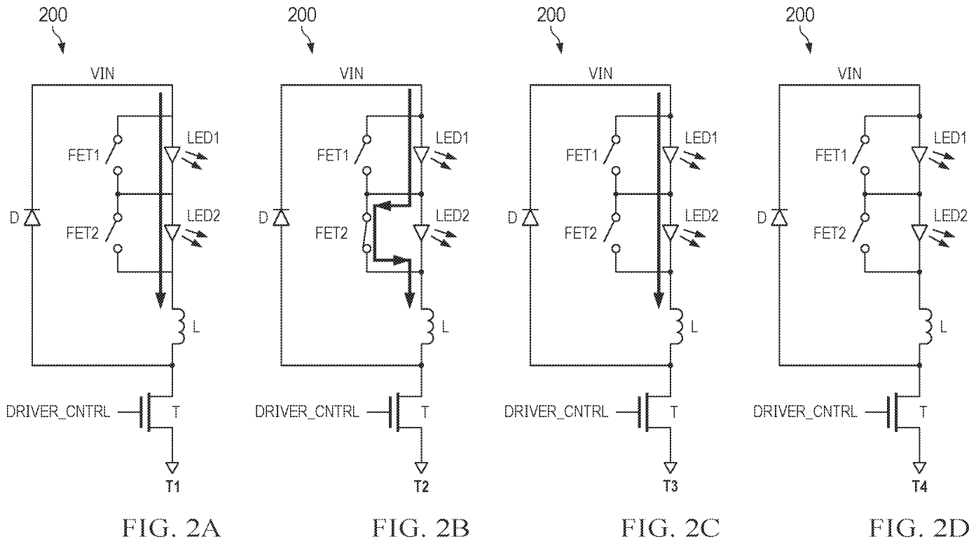

FIG. 2A, FIG. 2B, FIG. 2C and FIG. 2D illustrates an example dimming cycle of an LED lighting system 200 at different time instances t1, t2, t3 and t4, respectively. In some examples, the time instances t1, t2, t3 and t4 are subsequent to one another. Same labeling is utilized in FIG. 2A, FIG. 2B, FIG. 2C and FIG. 2D to depict the same structure. In some examples, the LED lighting system 200 can correspond to the system 100 in FIG. 1. It is noted herein that not all parts of the LED lighting system 200 are depicted herein for clarity purposes. However, all the features of the system 100 are also applicable to the LED lighting system 200. The LEDs, LED1 and LED2 in FIG. 2A, FIG. 2B, FIG. 2C and FIG. 2D, can correspond to the plurality of LEDs within the LED array 102 in FIG. 1, and the FETs, FET1 and FET2 in FIG. 2A, FIG. 2B, FIG. 2C and FIG. 2D, can correspond to the plurality of switches within the switch circuit 116 in FIG. 1. While for ease of explanation in the examples in FIG. 2A, FIG. 2B, FIG. 2C and FIG. 2D, the LED lighting system 200 is shown to include only two LEDS and two switches, there can be any number of switches and LEDs. The switch T, the inductor L and the diode D in FIG. 2A, FIG. 2B, FIG. 2C and FIG. 2D can correspond to the switching LED driver circuit 108 in FIG. 1. In an example, the switching LED driver circuit 108 includes the inductor L coupled to the second terminal 112, the diode D coupled between the inductor L and the first terminal 110, and the switch T coupled between the inductor L and a voltage supply terminal, such as ground.

FIG. 2A depicts an operation of the LED lighting system 200 at the time instance t1. The operation of the LED lighting system 200 is explained herein with reference to the system 100 in FIG. 1. At t1, the plurality of switches of the switch circuit 116 is turned off. In particular, in FIG. 2A, the FET1 and FET2 are turned off. Further, at t1, the switching LED driver circuit 108 is turned on (e.g., enabled to provide the LED current I_{LED} responsive to the driver control signal 138) and therefore, the LED current I_{LED} passes through the plurality of LEDs of the LED array 102. In particular, in FIG. 2A, the LED current I_{LED} passes through the LEDs, LED1 and LED2. Therefore, at t1, the LED array 102 provides the maximum brightness or minimum dimming. The plurality of switches (e.g., FET1 and FET2) is turned off based on a first plurality of values of the plurality of switch control signals 123 in FIG. 1. The switch logic circuit 118 is configured to provide the first plurality of values of the plurality of switch control signals based on a first plurality of values of the plurality of controller output signals 125 and a first value of the switch logic signal 126.

The switching driver control circuit 128 is configured to provide the first value of the switch logic signal 126 based on the first plurality of values of the plurality of controller output signals 125. At the time instance t1, each value of the first plurality of values of the plurality of controller output signals 125 is the same (e.g., logic HIGH). Further, at the time instance t1, each value of the first plurality of values of the plurality of switch control signals 123 is the inverse (e.g., logic LOW) or inverse logic level of a corresponding value of the first plurality of values of the plurality of controller output signals 125, thereby turning off the plurality of switches (e.g., FET1 and FET2). In some examples, the first value of the switch logic signal 126 operates to keep the first plurality of values of the plurality of switch control signals 123 to be the inverse (or inverse logic level) of the first plurality of values of the plurality of controller output signals 125. At t1, the switching driver control circuit 128 is further configured to provide a first value of a driver output signal 136 based on the first plurality of values of the plurality of controller output signals 125. In some examples, the first value of the driver output signal 136 operates to keep the switching LED driver circuit 108 tuned on at t1.

FIG. 2B depicts an operation of the LED lighting system 200 at the time instance t2. The operation of the LED lighting system 200 is explained herein with reference to the system 100 in FIG. 1. At t2, one or more switches of the plurality of switches of the switch circuit 116 are turned off. In some examples, the one or more switches is lesser than a total number of switches in the plurality of switches of the switch circuit 116. In particular, in FIG. 2A, the FET1 is turned off and FET2 is turned on. Further, at t2, the switching LED driver circuit 108 is turned on (e.g., responsive to driver control signal 138) and therefore, the LED current I_{LED} passes through one or more LEDs of the plurality of LEDs of the LED array 102 that are coupled in parallel to the one or more switches that are turned off. In particular, in FIG. 2A, the LED current I_{LED} passes through the LED1 and the LED current I_{LED} does not pass through LED2. Therefore, at t2, the LED array 102 provides less than the maximum brightness. The one or more switches of the plurality of switches (e.g., FET1) is turned off based on a second plurality of values of the plurality of switch control signals 123 in FIG. 1. The switch logic circuit 118 is configured to provide the second plurality of values of the plurality of switch control signals 123 based on a second plurality of values of the plurality of controller output signals 125 and a second value the switch logic signal 126.

The switching driver control circuit 128 is configured to provide the second value of the switch logic signal 126 based on the second plurality of values of the plurality of controller output signals 125. At the time instance t2, one or more values of the second plurality of values of the plurality of controller output signals 125 different from other values of the second plurality of values of the plurality of controller output signals 125. Further, at the time instance t2, each value of the second plurality of values of the plurality of switch control signals 123 is the inverse (or inverse logic level) of a corresponding value of the second plurality of values of the plurality of controller output signals 125. In some examples, the second value of the switch logic signal 126 operates to keep the second plurality of values of the plurality of switch control signals 123 to be the inverse (or inverse logic level) of the second plurality of values of the plurality of controller output signals 125. In some examples, the first value of the switch logic signal 126 at time instance t1 and the second value of the switch logic signal 126 at the time instance t2 may be the same. At t2, the switching driver control circuit 128 is further configured to provide a second value of a driver output signal 136 based on the second plurality of values of the plurality of controller output signals 125. In some examples, the second value of the driver output signal 138 operates to keep the switching LED driver circuit 108 turned on at t2. In some examples, the first value of the driver output signal 136 in FIG. 2A and the second value of the driver output signal 136 in FIG. 2B are the same.

FIG. 2C depicts an operation of the LED lighting system 200 at the time instance t3. The operation of the LED lighting system 200 is explained herein with reference to the system 100 in FIG. 1. At t3, the plurality of switches of the switch circuit 116 are turned off. In particular, in FIG. 2C, the switches FET1 and FET2 are turned off; thus, avoiding conduction losses through FET1 and FET2. Further, at t3, the switching LED driver circuit 108 is turned off. Although the switching LED driver circuit 108 is turned off (e.g., responsive to the driver control signal 138), the LED current I_{LED} stays high at t3 due to the presence of the inductor (e.g., L in FIG. 2C) associated with the switching LED driver circuit 108. Therefore, at t3, the LED current I_{LED} passes through the plurality of LEDs of the LED array 102 until the LED current I_{LED} drops to zero. In particular, in FIG. 2C, the LED current I_{LED} passes through the LEDs, LED1 and LED2. In some examples, the LED current I_{LED} that passes through the plurality of LEDs at t3 is referred to as a residual inductor current. The plurality of switches (e.g., FET1 and FET2) is turned off based on a third plurality of values of the plurality of switch control signals 123 in FIG. 1. The switch logic circuit 118 is configured to provide the third plurality of values of the plurality of switch control signals 123 based on a third plurality of values of the plurality of controller output signals 125 and a third value of the switch logic signal 126.

The switching driver control circuit 128 is configured to provide the third value of the switch logic signal 126 based on the third plurality of values of the plurality of controller output signals 125. At the time instance t3, each value of the third plurality of values of the plurality of controller output signals 125 is the same (e.g., logic LOW). In some examples, the third plurality of values of the plurality of controller output signals 125 in FIG. 2C is inverse (or inverse logic level) of the first plurality of values of the plurality of controller output signals 125 in FIG. 2A. Further, at the time instance t3, each value of the third plurality of values of the plurality of switch control signals 123 has the same logic level (e.g., logic LOW) as a corresponding value of the third plurality of values of the plurality of controller output signals 125. In some examples, the third value of the switch logic signal 126 operates to keep the third plurality of values of the plurality of switch control signals 123 to be in the same logic level as the third plurality of values of the plurality of controller output signals 125. At t3, the switching driver control circuit 128 is further configured to provide a third value of a driver output signal 136 based on the third plurality of values of the plurality of controller output signals 125. In some examples, the third value of the driver output signal 128 operates to keep the switching LED driver circuit 108 turned off at t3.

FIG. 2D depicts an operation of the LED lighting system 200 at the time instance t4. The operation of the LED lighting system 200 is explained herein with reference to the system 100 in FIG. 1. At t4, the LED current I_{LED} (or the residual inductor current) that passes through the plurality of LEDs reduces to zero. All the other features related to the operation of the LED lighting system 200 at the time instance t4 is same as at the time instance t3 and is therefore not repeated herein.

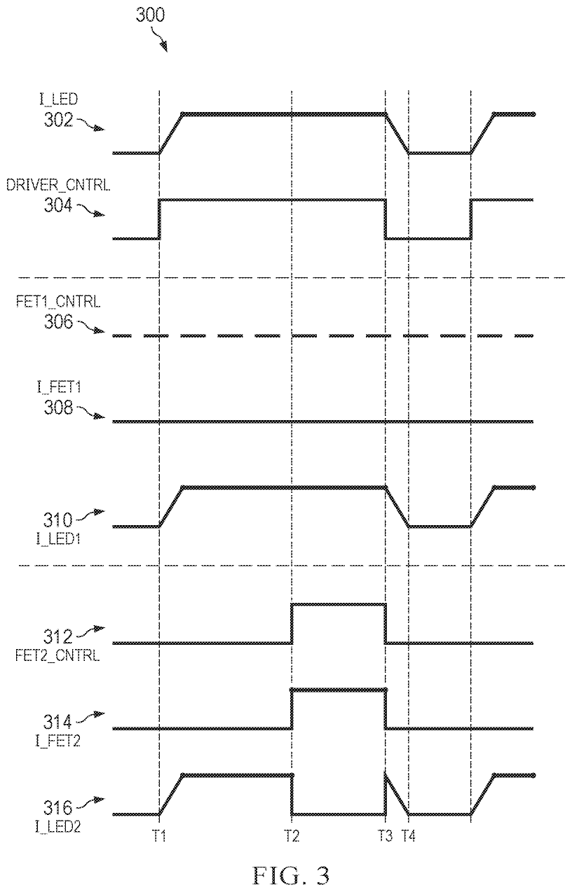

FIG. 3 illustrates an example plot 300 depicting the dimming cycle of the LED lighting system 200 in FIG. 2A, FIG. 2B, FIG. 2C and FIG. 2D. The plot 300 is explained herein with reference to FIG. 1, FIG. 2A, FIG. 2B, FIG. 2C and FIG. 2D. As can be seen in FIG. 3, at t1, the DRIVER_CNTRL 304 (e.g., the driver control signal 138 in FIG. 1) is at logic HIGH (e.g., has a first value) and therefore the switching LED driver circuit 108 in FIG. 1 is turned on. Therefore, at t1, the LED current I_LED 302 (e.g., the LED current I_{LED} in FIG. 1) from the switching LED driver circuit 108 rise gradually to reach a maximum value of LED current due to the presence of the inductor L. At t1, further, FET1_CNTRL 306 and FET2_CNTRL 312 (e.g., the plurality of switch control signals 123 in FIG. 1) are kept at logic LOW (e.g., has a first set of values), thereby turning off the FET1 and FET2 as shown in FIG. 2A. Because FET1 and FET2 are turned off, the LED current I_LED 302 cannot flow through FET1 and FET2 at t1. Therefore, the current I_FET1 306 through the FET1 and the current I_FET2 314 through the FET2 are zero at t1, as can be seen in FIG. 3. Because the LED current I_LED 302 cannot flow through FET1 and FET2, at t1, the LED current I_LED 302 flows through LED1 and LED2, as shown by the current I_LED1 310 through LED1 and the current I_LED2 316 through LED2.

At t2, the DRIVER_CNTRL 304 (e.g., the driver output signal 136 in FIG. 1) is at logic HIGH (e.g., has a second value) and therefore the switching LED driver circuit 108 in FIG. 1 is kept turned on. Further, at t2, FET1_CNTRL 306 is kept at logic LOW and FET2_CNTRL 312 is kept at logic HIGH and therefore, FET1 is kept turned off and FET2 is turned on. Because FET1 is turned off and FET2 is turned on, the LED current I_LED 302 cannot flow through FET1 and can flow through FET2. Therefore, at t2, the current I_FET1 308 through the FET1 is zero and the current I_FET2 312 through FET2 corresponds to the LED current I_LED 302. Because the LED current I_LED 302 cannot flow through FET1 and can flow through FET2, at t2, the LED current I_LED 302 flows through LED1 and does not flow through LED2, as shown by the current I_LED1 310 through LED1 and the current I_LED2 316 through LED2.

At t3, the DRIVER_CNTRL 304 (e.g., the driver output signal 136 in FIG. 1) is at logic LOW (e.g., has a third value) and therefore the switching LED driver circuit 108 in FIG. 1 is turned off. However, at t3, due to the presence of the inductor L, the LED current I_LED 302 still flows from the switching LED driver circuit 108 until the LED current I_LED 302 gradually reduces to zero. Further at t3, FET1_CNTRL 306 and FET2_CNTRL 312 are at logic LOW and therefore, FET1 and FET2 are turned off. Because FET1 and FET2 are turned off, the LED current I_LED 302 cannot flow through FET1 and FET2. Therefore, at t3, the current I_FET1 308 through the FET1 and the current I_FET2 314 through FET2 are each zero. Because the LED current I_LED 302 cannot flow through FET1 and FET2, at t3, the LED current I_LED 302 flows through LED1 and LED2, as shown by the current I_LED1 310 through LED1 and the current I_LED2 316 through LED2.

At t4, the DRIVER_CNTRL 304 (e.g., the driver output signal 136 in FIG. 1) is at logic LOW (e.g., has the third value) and therefore the switching LED driver circuit 108 in FIG. 1 is kept turned off. The LED current I_LED 302 is reduced to zero at t4. Further at t4, FET1_CNTRL 306 and FET2_CNTRL 312 are kept at logic LOW and therefore, FET1 and FET2 are turned off. Therefore, the current I_FET1 308 through the FET1 and the current I_FET2 through FET2 are zero at t4. Further, because the LED current I_LED 302 is zero at t4, no current flows through LED1 and LED2, as shown by the current I_LED1 310 through LED1 and the current I_LED2 316 through LED2.

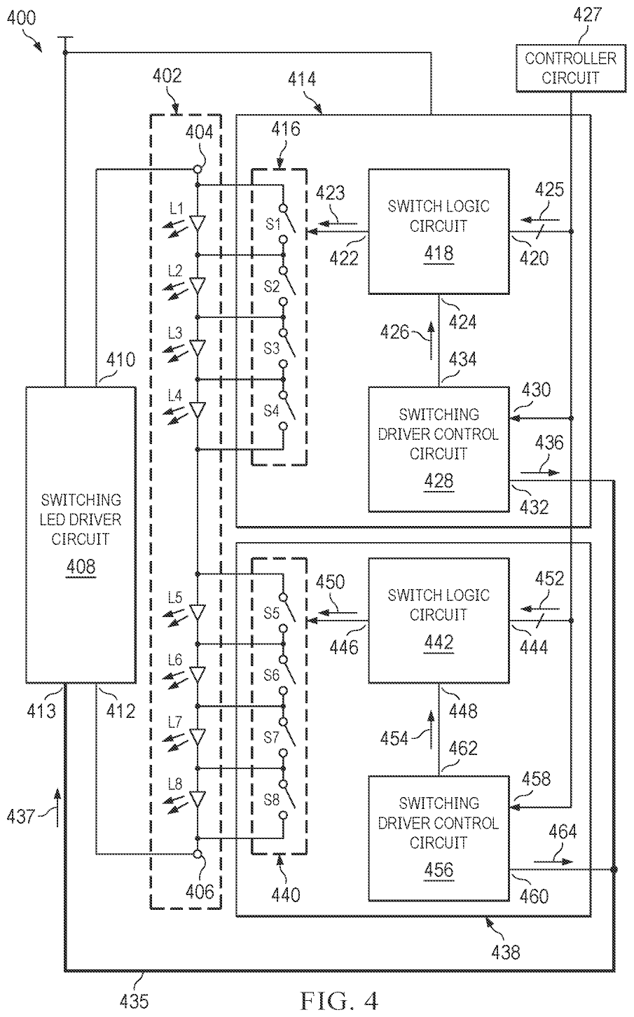

FIG. 4 illustrates a block diagram of an example system 400. In some examples, the system 400 includes a light emitting diode (LED) lighting system that facilitates dimming control of an LED array. The system 400 includes an LED array 402 that includes a first plurality of LEDs L1, L2, L3 and L4, and a second plurality of LEDs L5, L6, L7 and L8 coupled in series between a series input terminal 404 and a series output terminal 406 of the LED array 402. Further, the first plurality of LEDs L1, L2, L3 and L4 and the second plurality of LEDs L5, L6, L7 and L8 are coupled in series to one another. In this example, both the first plurality of LEDs and the second plurality of LEDs includes only four LEDs. However, in other examples, the first plurality of LEDs and the second plurality of LEDs can have more or less than four LEDs. The system 400 further includes a switching LED driver circuit 408 having a first terminal 410 coupled to the series input terminal 404 of the LED array 402 and a second terminal 412 coupled to the series output terminal 406 of the LED array 402. The switching LED driver circuit 408 is configured to provide an LED current I_{LED} to the first plurality of LEDs L1, L2, L3 and L4, and the second plurality of LEDs L5, L6, L7 and L8. The switching LED driver circuit 408 further includes an LED driver control input 413.

The system 400 further includes a first controller circuit 414 that includes a first switch circuit 416 having a first plurality of switches S1, S2, S3 and S4, each switch of the first plurality of switches S1, S2, S3 and S4 having a respective first switch terminal, a respective second switch terminal and a respective switching terminal. The first plurality of switches S1, S2, S3 and S4 is coupled in series to one another via the respective first switch terminals and the second switch terminals. In this example, the first plurality of switches includes four switches S1, S2, S3 and S4. However, in other examples, the first plurality of switches can include more or less than four switches. Each switch of the first plurality of switches S1, S2, S3 and S4 is coupled in parallel with a respective one of the first plurality of LEDs L1, L2, L3 and L4. In particular, in this example, S1 is coupled in parallel to L1, S2 is coupled in parallel to L2, S3 is coupled in parallel to L3 and S4 is coupled in parallel to L4. The first controller circuit 414 further includes a first switch logic circuit 418 including a first plurality of switch logic input terminals 420, a first plurality of switch logic output terminals 422 and a first switch control terminal 424. The first plurality of switch logic input terminals 420 and the first plurality of switch logic output terminals 422 are depicted herein as single terminals for case of reference. Each switch logic output terminal of the first plurality of switch logic output terminals 422 is coupled to the switching terminal of a respective one of the first plurality of switches S1, S2, S3 and S4.

The first switch logic circuit 418 is configured to provide a respective first plurality of switch control signals 423 at the respective first plurality of switch logic output terminals 422. The first plurality of switch control signals 423 is depicted herein as a single switch control signal 423 for the case of reference. Further, the numeral 423 is used herein interchangeably to refer to a single switch control signal and the first plurality of switch control signals. The first plurality of switches S1, S2, S3 and S4 are configured to turn on or turn off based on the respective first plurality of switch control signals 423. The first switch logic circuit 418 is configured to provide the respective first plurality of switch control signals 423 based on a respective first plurality of controller output signals 425 at the first plurality of switch logic input terminals 420 and a first switch logic signal 426 at the first switch control terminal 424. In particular, the switch control signal 423 at each of the first plurality of switch logic output terminals 422 is determined based on a value of a respective one of the first plurality of controller output signals 425 and a value of the first switch logic signal 426. The first plurality of controller output signals 425 is depicted herein as a single controller output signal 425 for the case of reference. Further, the numeral 425 is used herein interchangeably to refer to a single controller output signal of the first plurality of controller output signals and the first plurality of controller output signals.

The first controller circuit 414 further includes a first switching driver control circuit 428 that includes a first plurality of driver input terminals 430, a first driver output terminal 432 and a first driver logic terminal 434. The first plurality of driver input terminals 430 is depicted herein as a single terminal for ease of reference. The first driver logic terminal 434 is coupled to the first switch control terminal 424 of the first switch logic circuit 418, and each of the first plurality of driver input terminals 430 is coupled to a respective one of the first plurality of switch logic input terminals 420. Further, the first driver output terminal 432 is coupled to the LED driver control input 413 of the switching LED driver circuit 408 via a global BUS 435. The first switching driver control circuit 428 is configured to provide the first switch logic signal 426 at the first driver logic terminal 434 and a first driver output signal 436 at the first driver output terminal 432 based on the first plurality of controller output signals 425. In some examples, the first switching driver control circuit 428 is configured to provide the first driver output signal 436 to the global BUS 435 that is coupled to the LED driver control input 413, in order to control the switching LED driver circuit 408. In some examples, the global BUS 435 is configured to provide a driver control signal 437 to the LED driver control input 413 based on the first driver output signal 436. The switching driver control circuit 428 thus is configured to provide the first driver output signal 436 with value to turn on (e.g., enable) the switching LED driver circuit 408 for providing the LED current I_{LED} for activating any of the first plurality of LEDs L1, L2, L3 and L4. In some examples, the first controller circuit 414 may be implemented as an integrated circuit (IC). The system 400 further includes a controller circuit 427 configured to provide the first plurality of controller output signals 425 respectively to the first plurality of switch logic input terminals 420 and the first plurality of driver input terminals 430.

The system 400 further includes a second controller circuit 438 that includes a second switch circuit 440 having a second plurality of switches S5, S6, S7 and S8, each switch of the second plurality of switches S5, S6, S7 and S8 having a respective first switch terminal, a respective second switch terminal and a respective switching terminal. The second plurality of switches S5, S6, S7 and S8 is coupled in series to one another via the respective first switch terminals and the second switch terminals. In this example, the second plurality of switches includes four switches S5, S6, S7 and S8. However, in other examples, the second plurality of switches can include more or less than four switches. Each switch of the second plurality of switches S5, S6, S7 and S8 is coupled in parallel with a respective one of the second plurality of LEDs L5, L6, L7 and L8. In particular, in this example, S5 is coupled in parallel to L5, S6 is coupled in parallel to L6, S7 is coupled in parallel to L7 and S8 is coupled in parallel to L8. The second controller circuit 438 further includes a second switch logic circuit 442 including a second plurality of switch logic input terminals 444, a second plurality of switch logic output terminals 446 and a second switch control terminal 448. The second plurality of switch logic input terminals 444 and the second plurality of switch logic output terminals 446 are depicted herein as single terminals for ease of reference. Each switch logic output terminal of the second plurality of switch logic output terminals 446 is coupled to the switching terminal of a respective one of the second plurality of switches S5, S6, S7 and S8.

The second switch logic circuit 442 is configured to provide a respective second plurality of switch control signals 450 at the respective second plurality of switch logic output terminals 446. The second plurality of switch control signals 450 is depicted herein as a single switch control signal 450 for the case of reference. Further, the numeral 450 is used herein interchangeably to refer to a single switch control signal and the second plurality of switch control signals. The second plurality of switches S5, S6, S7 and S8 are configured to turn on or turn off based on the respective second plurality of switch control signals 450. The second switch logic circuit 442 is configured to provide the respective second plurality of switch control signals 450 based on a respective second plurality of controller output signals 452 at the second plurality of switch logic input terminals 444 and a second switch logic signal 454 at the second switch control terminal 448. In particular, the switch control signal 450 at each of the second plurality of switch logic output terminals 446 is determined based on a value of a respective one of the second plurality of controller output signals 452 and a value of the second switch logic signal 454. The second plurality of controller output signals 452 is depicted herein as a single controller output signal 452 for the case of reference. Further, the numeral 452 is used herein interchangeably to refer to a single controller output signal of the second plurality of controller output signals and the second plurality of controller output signals.

The second controller circuit 438 further includes a second switching driver control circuit 456 that includes a second plurality of driver input terminals 458, a second driver output terminal 460 and a second driver logic terminal 462. The second plurality of driver input terminals 458 is depicted herein as a single terminal for ease of reference. The second driver logic terminal 462 is coupled to the second switch control terminal 448 of the second switch logic circuit 442, and each of the second plurality of driver input terminals 458 is coupled to a respective one of the second plurality of switch logic input terminals 444. Further, the second driver output terminal 460 is coupled to the LED driver control input 413 of the switching LED driver circuit 408 via the global BUS 435. The second switching driver control circuit 456 is configured to provide the second switch logic signal 454 at the second switch control terminal 462 and a second driver output signal 464 at the second driver output terminal 460 based on the second plurality of controller output signals 452. In some examples, the second switching driver control circuit 456 is configured to provide the second driver output signal 464 to the global BUS 435 that is coupled to the LED driver control input 413, in order to control the switching LED driver circuit 408. In some examples, the global BUS 435 is configured to provide the driver control signal 437 to the LED driver control input 413 further based on the second driver output signal 464. The switching driver control circuit 456 thus is configured to provide the second driver output signal 464 with value to turn on (e.g., enable) the switching LED driver circuit 408 for providing the LED current I_{LED} for activating any of the second plurality of LEDs L5, L6, L7 and L8. In some examples, the first driver output terminal 432 of the first switching driver control circuit 428 and the second driver output terminal 460 of the second switching driver control circuit 456 are coupled to one another via the global bus 435. In some examples, the second controller circuit 438 may be implemented as an integrated circuit (IC). The controller circuit 427 is further configured to provide the second plurality of controller output signals 452 respectively to the second plurality of switch logic input terminals 444 and the second plurality of driver input terminals 458.

A dimming cycle of the first plurality of LEDs in conjunction with the first controller circuit 414 is the same as the dimming cycle as explained above with respect to the LED lighting system 200 in FIG. 2A, FIG. 2B, FIG. 2C and FIG. 2D, and is therefore not repeated herein. Similarly, a dimming cycle of the second plurality of LEDs in conjunction with the second controller circuit 438 is the same as the dimming cycle as explained above with respect to the LED lighting system 200 in FIG. 2A, FIG. 2B, FIG. 2C and FIG. 2D, and is therefore not repeated herein. Further, in the system 400 in FIG. 4, at t1 (as explained above in FIG. 2A), the first plurality of controller output signals 425 and the second plurality of controller output signals 452 have the same value (e.g., logic HIGH). Further, at t3 (as explained above in FIG. 2C), the first plurality of controller output signals 425 and the second plurality of controller output signals 452 have the same value (e.g., logic LOW). In system 400, the switching LED driver circuit 408 is turned off at t3, only when both the first plurality of controller output signals 425 and the second plurality of controller output signals 452 have the same value (e.g., logic LOW).

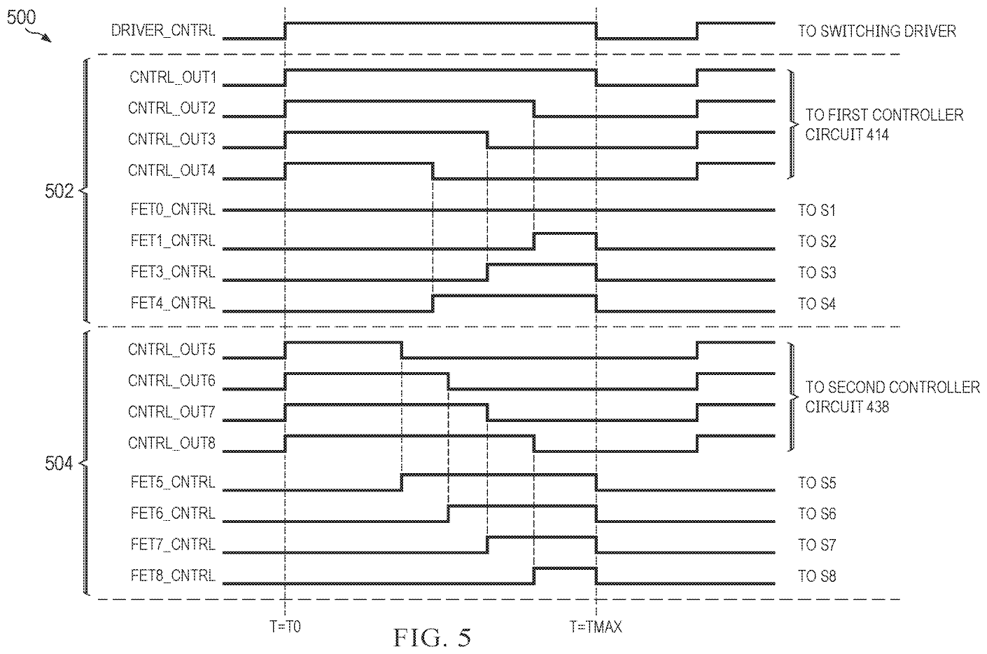

FIG. 5 depicts an example plot 500 illustrating waveforms of the system 400 in FIG. 4. Therefore, the plot 500 is explained herein with reference to the system 400 in FIG. 4. The plot 500 includes a first set of signals 502 associated with operation of the first controller circuit 414 and a second set of signals 504 associated with operation of the second controller circuit 438. The signals CNTRL_OUT1, CNTRL_OUT2, CNTRL_OUT3 and CNTRL_OUT4 corresponds to the first plurality of controller signals 425 in FIG. 4, and the signals FET0_CNTRL, FET1_CNTRL, FET3_CNTRL and FET4_CNTRL corresponds to the first plurality of switch control signals 423 in FIG. 4. Further, signals CNTRL_OUT5, CNTRL_OUT6, CNTRL_OUT7 and CNTRL_OUT8 corresponds to the second plurality of controller signals 452 in FIG. 4, and the signals FET6_CNTRL, FET7_CNTRL, FET8_CNTRL and FET9_CNTRL corresponds to the second plurality of switch control signals 450 in FIG. 4. At t0, the signals CNTRL_OUT1, CNTRL_OUT2, CNTRL_OUT3 and CNTRL_OUT4 are at logic HIGH (e.g., have the same value) and the signals CNTRL_OUT5, CNTRL_OUT6, CNTRL_OUT7 and CNTRL_OUT8 are also at logic HIGH (e.g., have the same value). Further, at t0, the signals FET0_CNTRL, FET1_CNTRL, FET3_CNTRL and FET4_CNTRL are at logic LOW and the signals FET6_CNTRL, FET7_CNTRL, FET8_CNTRL and FET9_CNTRL are also at logic LOW. In some examples, t0 corresponds to the time instance t1, as explained above in FIG. 2A.

At tmax, the signals CNTRL_OUT1, CNTRL_OUT2, CNTRL_OUT3 and CNTRL_OUT4 are at logic low (e.g., have the same value) and the signals CNTRL_OUT5, CNTRL_OUT6, CNTRL_OUT7 and CNTRL_OUT8 are also at logic low (e.g., have the same value). Further, at tmax, the signals FET0_CNTRL, FET1_CNTRL, FET3_CNTRL and FET4_CNTRL are at logic LOW and the signals FET6_CNTRL, FET7_CNTRL, FET8_CNTRL and FET9_CNTRL are also at logic LOW. In some examples, tmax corresponds to the time instance t3, as explained above in FIG. 2C. Further, during some time instances between t0 and tmax, one or more of the signals CNTRL_OUT1, CNTRL_OUT2, CNTRL_OUT3 and CNTRL_OUT4 are at logic HIGH and one or more of the signals CNTRL_OUT5, CNTRL_OUT6, CNTRL_OUT7 and CNTRL_OUT8 are at logic HIGH. During those time instances between t0 and tmax, a corresponding one or more of the signals FET0_CNTRL, FET1_CNTRL, FET3_CNTRL and FET4_CNTRL are at logic LOW and a corresponding one or more of the signals FET6_CNTRL, FET7_CNTRL, FET8_CNTRL and FET9_CNTRL are at logic LOW. In some examples, the time instances between t0 and tmax indicated herein can correspond to the time instance t2 in FIG. 2B.

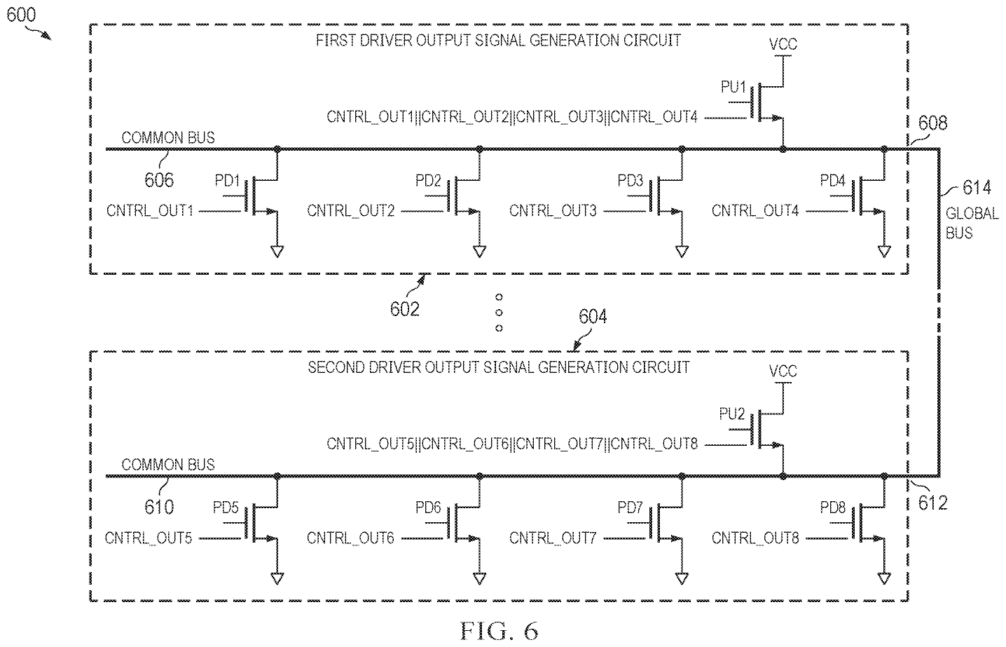

FIG. 6 illustrates an example driver output signal generation circuit 600. In some examples, the driver output signal generation circuit 600 is implemented as part of the system 400, in order to generate the first driver output signal 436 and the second driver output signal 464. The driver output signal generation circuit 600 includes a first driver output signal generation circuit 602 and a second driver output signal generation circuit 604. The first driver output signal generation circuit 602 may be implemented within the first switching driver control circuit 428 in FIG. 4 to generate the first driver output signal 436. Similarly, the second driver output signal generation circuit 604 may be implemented within the second switching driver control circuit 456 in FIG. 4 to generate the second driver output signal 464. Therefore, the driver output signal generation circuit 600 is explained herein with reference to the system 400 in FIG. 4. In this example, the driver output signal generation circuit 600 is shown to include two driver output signal generation circuits, that is, the first driver output signal generation circuit 602 and the second driver output signal generation circuit 604. However, in other examples, the driver output signal generation circuit 600 may include more or less than two driver output signal generation circuits. In particular, in the system 100 of FIG. 1, the driver output signal generation circuit 600 may include only a single driver output signal generation circuit that is implemented within the switching driver control circuit 128 to generate the driver output signal 136.

The first driver output signal generation circuit 602 includes a first common bus 606, one end of which is coupled to a first driver output terminal 608 (e.g., the driver output terminal 432 in FIG. 4). The first driver output signal generation circuit 602 further includes a first plurality of pulldown switches PD1, PD2, PD3 and PD4, each having a respective first terminal, a second terminal and a control terminal. The first terminal of each pulldown switch of the first plurality of pulldown switches PD1, PD2, PD3 and PD4 is coupled to the first common bus 606 and the second terminal of each pulldown switch of the plurality of pulldown switches PD1, PD2, PD3 and PD4 is coupled to a ground terminal. A respective one of the first plurality of controller output signals 425 in FIG. 4 at each of the first plurality of driver input terminals 430 in FIG. 4 is provided in an inverted form to the control terminal of each of the first plurality of pulldown switches PD1, PD2, PD3 and PD4. The first plurality of pulldown switches PD1, PD2, PD3 and PD4 is configured to selectively pulldown the first common bus 606 based on the value of the first plurality of controller output signals 425 in the inverted form. In particular, in FIG. 6, the first plurality of pulldown switches PD1, PD2, PD3 and PD4 is configured to pulldown the first common bus 606 when the value of each of the first plurality of controller output signals 425 in the inverted form is a logic HIGH. In other words, the first plurality of pulldown switches PD1, PD2, PD3 and PD4 is configured to pulldown the first common bus 606 when the value of each of the first plurality of controller output signals 425 is logic LOW.

The first driver output signal generation circuit 602 further includes a first pullup switch PU1 having a first terminal, a second terminal and a control terminal. The first terminal of the first pullup switch PU1 is coupled to VCC and the second terminal of the first pullup switch PU1 is coupled to the first common bus 606. A logical combination (e.g., a logical OR) of the first plurality of controller output signals 425 in FIG. 4 is provided to the control terminal of the pullup switch PU1, and the first pullup switch PU1 is configured to selectively pullup the first common bus 606 based on the logical combination of the first plurality of controller output signals 425. In particular, in FIG. 6, the first pullup switch PU1 is configured to pullup the first common bus 606 when the value of any of the first plurality of controller output signals 425 is a logic HIGH. The first common bus 606 is configured to provide a first driver output signal (e.g., the first driver output signal 436 in FIG. 4) indicative of a status of the first common bus 606 (e.g., the pulldown status or the pullup status) at the first driver output terminal 608 (e.g., the driver output terminal 432 in FIG. 4).

The second driver output signal generation circuit 604 includes a second common bus 610, one end of which is coupled to a second driver output terminal 612 (e.g., the driver output terminal 460 in FIG. 4). The second driver output signal generation circuit 604 further includes a second plurality of pulldown switches PD5, PD6, PD7 and PD8, each having a respective first terminal, a second terminal and a control terminal. The first terminal of each pulldown switch of the second plurality of pulldown switches PD5, PD6, PD7 and PD8 is coupled to the second common bus 610 and the second terminal of each pulldown switch of the second plurality of pulldown switches PD5, PD6, PD7 and PD8 is coupled to a ground terminal. A respective one of the second plurality of controller output signals 452 in FIG. 4 at each of the second plurality of driver input terminals 458 in FIG. 4 is provided in an inverted form to the control terminal of each of the second plurality of pulldown switches PD5, PD6, PD7 and PD8. The second plurality of pulldown switches PD5, PD6, PD7 and PD8 is configured to selectively pulldown the second common bus 610 based on the value of the second plurality of controller output signals 452 in the inverted form. In particular, in FIG. 6, the second plurality of pulldown switches PD5, PD6, PD7 and PD8 is configured to pulldown the second common bus 610 when the value of each of the second plurality of controller output signals 452 in the inverted form is a logic HIGH. In other words, the second plurality of pulldown switches PD5, PD6, PD7 and PD8 is configured to pulldown the second common bus 610 when the value of each of the second plurality of controller output signals 452 is logic LOW.

The second driver output signal generation circuit 604 further includes a second pullup switch PU2 having a first terminal, a second terminal and a control terminal. The first terminal of the second pullup switch PU2 is coupled to VCC and the second terminal of the second pullup switch PU2 is coupled to the second common bus 610. A logical combination (e.g., a logical OR) of the second plurality of controller output signals 452 in FIG. 4 is provided to the control terminal of the second pullup switch PU2, and the second pullup switch PU2 is configured to selectively pullup the second common bus 610 based on the logical combination of the second plurality of controller output signals 452. In particular, in FIG. 6, the second pullup switch PU2 is configured to pullup the second common bus 610 when the value of any of the second plurality of controller output signals 452 is a logic HIGH. The second common bus 610 is configured to provide a second driver output signal (e.g., the second driver output signal 464 in FIG. 4) indicative of a status of the second common bus 610 (e.g., the pulldown status or the pullup status) at the second driver output terminal 612 (e.g., the driver output terminal 460 in FIG. 4).

The first common bus 606 and the second common bus 610 are coupled to global bus 614. In some examples, the global bus 614 is pulled down, when both the first common bus 606 and the second common bus 610 are pulled down.

In this description, the term “based on” means based at least in part on.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be configured to couple to at least some of the passive elements and/or the sources to form the described structure, either at a time of manufacture or after a time of manufacture, such as by an end user and/or a third party.

Modifications are possible in the described embodiments, and other embodiments are possible, within the scope of the claims.

What is claimed is:

1. A circuit comprising:
a plurality of switches, each switch of the plurality of switches having a respective first switch terminal, a respective second switch terminal and a respective switching terminal;
a switch logic circuit including a plurality of switch logic input terminals, a plurality of switch logic output terminals and a switch control terminal, each switch logic output terminal of the plurality of switch logic output terminals being coupled to the switching terminal of a respective one of the plurality of switches; and
a switching driver control circuit including a plurality of driver input terminals, a driver output terminal and a driver logic terminal, the driver logic terminal being coupled to the switch control terminal of the switch logic circuit, and each of the plurality of driver input terminals being coupled to a respective one of the plurality of switch logic input terminals.

2. The circuit of claim 1, wherein each of the plurality of switches is configured to turn on and turn off based on a respective switch control signal at each of the plurality of switch logic output terminals.

3. The circuit of claim 2, further comprising a controller circuit configured to provide a plurality of controller output signals respectively to the plurality of switch logic input terminals, and the switch control signal at each of the plurality of switch logic output terminals is determined based on a value of a respective one of the plurality of controller output signals and a value of a switch logic signal at the driver logic terminal.

4. The circuit of claim 3, wherein:
the controller circuit is further configured to provide the plurality of controller output signals respectively to the plurality of driver input terminals, and
the value of the switch logic signal at the driver logic terminal and a value of a driver output signal at the driver output terminal are determined based on the plurality of controller output signals.

5. The circuit of claim 4, wherein the switching driver control circuit comprises:
a common bus, one end of which is coupled to the driver output terminal;
a plurality of pulldown switches, one terminal of each of the plurality of pulldown switches being coupled to the common bus; and
a pullup switch, one terminal of which is coupled to the common bus.

6. The circuit of claim 5, wherein a respective one of the plurality of controller output signals at each of the plurality of driver input terminals is provided in an inverted form to respective control terminals of the plurality of pulldown switches, and the plurality of pulldown switches is configured to selectively pulldown the common bus based on the value of the plurality of controller output signals in the inverted form.

7. The circuit of claim 6, wherein a logical combination of the plurality of controller output signals is provided to a control terminal of the pullup switch, and the pullup switch is configured to selectively pullup the common bus based on the logical combination of the plurality of controller output signals.

8. The circuit of claim 4 implemented as a first integrated circuit (IC), and wherein the plurality of switches is a first plurality of switches, the switch logic circuit is a first switch logic circuit and the switching driver control circuit is a first switching driver control circuit, the circuit further including a second IC that includes:
a second plurality of switches, each switch of the second plurality of switches having a respective first switch terminal, a respective second switch terminal and a respective switching terminal;
a second switch logic circuit including a respective plurality of switch logic input terminals, a respective plurality of switch logic output terminals and a respective switch control terminal, each switch logic output terminal of the respective plurality of switch logic output terminals being coupled to the switching terminal of a respective one of the second plurality of switches;
a second switching driver control circuit including a respective plurality of driver input terminals, a respective driver output terminal and a respective driver logic terminal, the respective driver logic terminal being coupled to the respective switch control terminal of the second switch logic circuit, and each of the respective plurality of driver input terminals being coupled to a respective one of the respective plurality of switch logic input terminals of the second switch logic circuit.

9. The circuit of claim 8, wherein the second plurality of switches is configured to turn on and turn off based on a respective switch control signal at each of the plurality of switch logic output terminals of the second switch logic circuit.

10. The circuit of claim 9, wherein:
the plurality of controller output signals at the plurality of switch logic input terminals of the first switch logic circuit is a first plurality of controller output signals, and wherein the controller circuit is further configured to provide a second plurality of controller output signals respectively to the plurality of switch logic input terminals of the second switch logic circuit, and
the switch control signal at each of the plurality of switch logic output terminals of the second switch logic circuit is determined based on a value of a respective one of the second plurality of controller output signals and a value of the switch logic signal at the driver logic terminal of the second switching driver control circuit.

11. The circuit of claim 10, wherein:
wherein the controller circuit is further configured to provide the second plurality of controller output signals respectively to the plurality of driver input terminals of the second switching driver control circuit, and
the value of the switch logic signal at the driver logic terminal of the second switching driver control circuit and a value of the driver output signal at the driver output terminal of the second switching driver control circuit are determined based on the second plurality of controller output signals.

12. The circuit of claim 8, wherein the driver output terminal of the first switching driver control circuit and the driver output terminal of the second switching driver control circuit are coupled to one another.

13. A circuit comprising:
a plurality of switches configured to turn on or turn off based on a respective plurality of switch control signals;
a switch logic circuit configured to provide the respective plurality of switch control signals based on a respective plurality of controller output signals and a switch logic signal;
a switching driver control circuit configured to provide the switch logic signal based on the respective plurality of controller output signals.

14. The circuit of claim 13, wherein:
the switch logic circuit is configured to provide a plurality of values of the plurality of switch control signals based on a plurality of values of the plurality of controller output signals and a value of the switch logic signal, each value of the plurality of values of the plurality of controller output signals being the same and the switching driver control circuit is configured to provide the value of the switch logic signal based on the plurality of values of the plurality of controller output signals such that the plurality of switches is turned off.

15. The circuit of claim 14, wherein the plurality of values of the plurality of switch control signals is a first plurality of values of the plurality of switch control signals, the plurality of values of the plurality of controller output signals is a first plurality of values of the plurality of controller output signals and the value of switch logic signal is a first value of the switch logic signal, and wherein
the switch logic circuit is configured to provide a second plurality of values of the plurality of switch control signals based on a second plurality of values of the plurality of controller output signals and a second value of the switch logic signal, wherein one or more values of the second plurality of values of the plurality of controller output signals is different from other values of the second plurality of values of the plurality of controller output signals and the switching driver control circuit is configured to provide the second value of the switch logic signal based on the second plurality of values of the plurality of controller output signals such that one or more switches of the plurality of switches are turned off, and
the one or more switches is lesser than a total number of switches in the plurality of switches.

16. The circuit of claim 15, wherein:
the switch logic circuit is configured to provide a third plurality of values of the plurality of switch control signals based on a third plurality of values of the plurality of controller output signals and a third value of the switch logic signal, wherein the third plurality of values of the plurality of controller output signals is inverse of the first plurality of values of the plurality of controller output signals and the switching driver control circuit is configured to provide the third value of the switch logic signal based on the third plurality of values of the plurality of controller output signals such that the plurality of switches is turned off.

17. The circuit of claim 16, wherein the switching driver control circuit is further configured to provide a driver output signal having a first value responsive to the plurality of controller output signals having the first plurality of values and having a second value responsive to the plurality of controller output signals having the second plurality of values, the first value and the second value being the same, and the driver output signal having a third, different value responsive to the plurality of controller output signals having the third plurality of values.

18. The circuit of claim 13 implemented as a first integrated circuit (IC), the plurality of switches is a first plurality of switches, the switch logic circuit is a first switch logic circuit, the switching driver control circuit is a first switching driver control circuit, the plurality of switch control signals is a first plurality of switch control signals and the plurality of controller output signals is a first plurality of controller output signals, the circuit further comprising a second IC that includes:
a second plurality of switches configured to turn on or turn off based on a respective second plurality of switch control signals;
a second switch logic circuit configured to provide the respective second plurality of switch control signals based on a respective second plurality of controller output signals and a respective switch logic signal;
a second switching driver control circuit configured to provide the respective switch logic signal based on the respective second plurality of controller output signals.

19. The circuit of claim 18, wherein the second switch driver control circuit is further configured to provide a respective driver output signal based on the second plurality of controller output signals and wherein the driver output signal of the first switching driver control circuit and the driver output signal of the second switching driver control circuit are configured to pulldown or pullup a global bus.

20. A system comprising:
a plurality of light emitting diodes (LEDs) coupled in series between a series input terminal and a series output terminal;
a switching LED driver circuit configured to provide an LED current to the plurality of LEDS;
a plurality of switches in which each switch is coupled in parallel with a respective one of the plurality of LEDs, wherein the plurality of switches is configured to turn on or turn off based on a respective plurality of switch control signals;
a switch logic circuit configured to provide the respective plurality of switch control signals based on a respective plurality of controller output signals and a switch logic signal;
a switching driver control circuit configured to provide the switch logic signal to the switch logic circuit and a driver output signal to control the switching LED driver circuit, based on the respective plurality of controller output signals; and
a controller circuit configured to provide the respective plurality of controller output signals to the switch logic circuit and the switching driver control circuit.

21. The circuit of claim 20, wherein:
the switch logic circuit is configured to provide a plurality of values of the plurality of switch control signals based on a plurality of values of the plurality of controller output signals and a value of the switch logic signal, each value of the plurality of values being the same and the switching driver control circuit is configured to provide the value of the switch logic signal and a value of the driver output signal based on the plurality of values of the plurality of controller output signals such that the plurality of switches is turned off and the switching LED driver circuit is turned on.

22. The circuit of claim 21, wherein:
the plurality of values of the plurality of controller output signals is a first plurality of values and the plurality of values of the plurality of switch control signals is a first plurality of switch control signals, the value of switch logic signal is a first value of the switch logic signal and the value of the driver output signal is a first value of the driver output signal, and
the switch logic circuit is configured to provide a second plurality of values of the plurality of switch control signals based on a second plurality of values of the plurality of controller output signals wherein one or more values of the second plurality of values of the plurality of controller output signals is different from the other values of the second plurality of values of the plurality of controller output signals and the switching driver control circuit is configured to provide a second value of the switch logic signal and a second value of the driver output signal based on the second plurality of values of the plurality of controller output signals such that one or more switches of the plurality of switches are turned on and the switching LED driver circuit is turned on, and
the one or more switches is lesser than a total number of switches in the plurality of switches.

23. The circuit of claim 22, wherein:
the switch logic circuit is configured to provide a third plurality of values of the plurality of switch control signals based on a third plurality of values of the plurality of controller output signals wherein the third plurality of values of the plurality of controller output signals is inverse of the first plurality of values of the plurality of controller output signals and the switching driver control circuit is configured to provide a third value of the switch logic signal and a third value of the driver output signal based on the third plurality of values of the plurality of controller output signals such that the plurality of switches is turned off and the switching LED driver circuit is turned off.

24. The system of claim 20, further comprising:
an inductor coupled in series with the plurality of LEDs, wherein:
the plurality of LEDs is a first plurality of LEDs, the system further including a second plurality of LEDs coupled in series between the series input terminal and the series output terminal, wherein the first plurality of LEDs and the second plurality of LEDs are coupled in series to one another, and
the plurality of switches is a first plurality of switches, the switch logic circuit is a first switch logic circuit, the switching driver control circuit is a first switching driver control circuit, the plurality of switch control signals is a first plurality of switch control signals and the plurality of controller output signals is a first plurality of controller output signals, the system further comprising:
a second plurality of switches in which each switch is coupled in parallel with a respective one of the second plurality of LEDs, wherein the second plurality of switches is configured to turn on or turn off based on a respective second plurality of switch control signals;
a second switch logic circuit configured to provide the respective second plurality of switch control signals based on a respective second plurality of controller output signals and a respective switch logic signal;
a second switching driver control circuit configured to provide the respective switch logic signal to the second switch logic circuit and a respective driver output signal to control the switching LED driver circuit, based on the respective second plurality of controller output signals.
